(19) United States
(12) Patent Application Publication
(10) Pub. No.: US 2013/0121010 A1
(43) Pub. Date: May 16, 2013

(54) Automobile Light Covering Device and Method

(71) Applicant: Nell McClendon, Calumet Park, IL (US)

(72) Inventor: Nell McClendon, Calumet Park, IL (US)

(21) Appl. No.: 13/668,654

(22) Filed: Nov. 5, 2012

Related U.S. Application Data
(60) Provisional application No. 61/558,031, filed on Nov. 10, 2011.

(51) Int. Cl. B60Q 1/00; H01R 43/00; B32B 38/10; B23P 11/00

(52) U.S. Cl. 362/520; 29/592.1; 29/825; 156/249

(57) ABSTRACT

Disclosed is a vehicular communication method and device that displays a message when a vehicle light source is energized, sending the message to nearby motorists. The device increases good-will between drivers or alternatively provides a directed message to other drivers. A vehicle light, such as a rear brake light, turn signal or emergency vehicle light includes a housing having an outer translucent panel. The panel includes an etched or overlaid message such that a message is visualized when the internal light is energized. The message is readily visualized without compromising the luminosity of the lamp or the amount of light required under state and federal vehicle regulations. An embodiment includes a message that is adhered over an existing vehicle light housing using an adhesive film, while another embodiment contemplates the outer panel including the message in its construction.

### CROSS REFERENCE TO RELATED APPLICATION

This application claims the benefit of U.S. Provisional Application No. 61/558,031 filed on Nov. 10, 2011, entitled “Auto Thank You Taillight Cover.” The above identified patent application is herein incorporated by reference in its entirety to provide continuity of disclosure.

### BACKGROUND OF THE INVENTION

1. Field of the Invention

The present invention relates to vehicle messaging devices and automotive personalization means. More specifically, the present invention pertains to a method and device for projecting a message from a vehicle operating light such that nearby motorists are notified of a specific message or are presented with a message and engenders good-will to reduce road rage.

Communication between motorists on roadways and highways can be quite minimal during high traffic times and in high traffic areas. Driver tend to be in a rush to get to their intended destination, are preoccupied with their own thoughts or distractions, and further can be frustrated with the traffic conditions. This promotes an adversarial environment between motorists, where polite social conduct is replaced with a confrontational environment that is not conducive to safety. Motorists tend to forget that dangerous behavior or reckless driving can place human lives at stake, where expediency and efficiency are placed at a higher premium than public health. This commonly manifests itself in “road rage,” where drivers act drastically to spite other drivers. This can lead to exchanges between motorists and dangerous altercations. It is recognized that this phenomenon on roadways is a real public concern, and one that can be addressed through increased communication and awareness.

To address this common hazard and public concern, it is desired to disclose an improved means of communication between motorists. While direct and continuous communication may be too burdensome, a friendly message to other motorists is a basic means of communication that can serve as an effective reminder that the motorist is another person and not an adversary to cut off or endanger. Emotionally charged driving situations can be avoided or tempered by way of a simple friendly message and gesture that reminds everyone that safety is of primary concern and haste in the current situation does not allow for endangering others. A common situation in which drivers can become unfriendly and hostile are merging intersections, where one motorist is attempting to enter the flow of traffic from another causeway or on-ramp. Some drivers must yield, while all drivers can be courteous to one another. However, in high congestion or high speed areas, this traffic scenario can lead to confrontation and anger if either motorist does not follow the rules of the road or act courteous to one another.

The present invention discloses a vehicular message positioned over an operating light, such as a taillight or turn signal, whereby a friendly message can be relayed between motorists. The message is adapted to build goodwill between drivers and remind them of roadway safety and engage in courteous driving. An adhesive layer having a defined message is placed over a vehicle light, or alternatively the outer covering of a light housing can be adorned, etched or otherwise marked with the message such that the illumination from the energized light is partially blocked to outline the message while also not blocking the functionality of the light. In the example above, a driver can show appreciation to a driver therebehind when merging into traffic. In an alternate use of the present invention, an emergency vehicle can activate an emergency light that provides illumination, emergency notice and a directed message for other motorists. The present invention enhances communication above and beyond the traditional vehicle signals on existing automobiles.

2. Description of the Prior Art

Devices have been disclosed in the prior art that relate to automotive signaling and sign devices. These include devices that have been patented and published in patent application publications, and generally relate to illuminated housing having a placard or sign for fellow motorists to see. Most require splicing the housing wiring connections into the vehicle's electrical harnesses, which can be difficult, require professional installation, void warranties and create safety hazards if conducted improperly. The present invention is a passive cover or light housing panel that includes a message or indicia, whereby DOT regulations for light coverings are not violated and the message requires not additional installation beyond placement of a film over an existing light or replacing an original equipment light with an identical one having a message thereon. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,404,334 to Chao discloses a taillight module for an automobile comprising an assembly that attaches to the license plate groove along the backside of the vehicle. The assembly includes a plurality of lamps disposed within a base, the lamps connecting to vehicle lights that activate based on different inputs from the vehicle, including brake lights, turn signals and reverse lights. A display plate is mounted over the light base and includes a message, indicia or warning that is secured to the base by a housing that secures over the display plate and secures to the base, sandwiching the plate therebetween. The assembly is adapted to adhere to the vehicle license plate groove or secure thereto using the license plate screws. The Chao device is an assembly that includes its own lighting and connects to the wiring of the vehicle to relay signals and messages to drivers behind the attached vehicle. The present invention comprises a message system that does not require replacement of existing vehicle lighting hardware or attachment thereto, but includes an etched light cover or adhesable film attachable thereover.

Similar to the Chao device is U.S. Pat. No. 7,020,992 to Christie, which discloses a message display assembly for a vehicle that includes a housing mountable to the inner surface of a vehicle rear window for projecting signals rearward. The display is an electronic interface that receives signals from an input, whereby messages can be selected and displayed from the device and through the rear window of the vehicle. The mounting assembly includes a bracket, a panel and an adhesive for securing the display to an angled window and securing its position while the vehicle is in motion. The Christie device includes an electronic display that can project unique messages based on electrical input from the user through a keyboard device. The present invention pertains to a static message either placed onto an existing vehicle light or included in the light housing for displaying the image while the light is energized.

U.S. Pat. No. 7,834,752 to Kuvantrarai discloses a brake-actuated message device that comprises a casing having a front panel, a plurality of lights for illuminating the front panel, and a message placed on the front panel. The lights are wired into the braking lights to energize when the driver depresses the brake pedal, thereby illuminating the device and displaying the panel message. Several embodiments are disclosed for the purpose of illuminating a panel using lights illuminated when the user depresses the brake pedal. However, the Kuvantrarai requires connecting the assembly to a vehicle brake wiring harness. The present invention provides a readily attachable film that is placed over existing light sources on a vehicle to illuminate a message, without requiring installation or modification of an existing vehicle wiring.

Finally, U.S. Pat. No. 5,939,979 to Lee discloses a light system for a vehicle that comprises a light cover having at least one light-illuminable area adapted to display a vehicle trademark symbol during light and dark conditions. The device activates the illuminating means when the driver performs a specific action, such as brake input, turn signaling, hazard lights, reverse lights or similar input. A combination of light penetrable and impenetrable material is utilized to form the vehicle company trademark or logo, where the light-emitting means illuminates light through portions of the cover and not others. Similar to the foregoing prior art references, the Lee device is required to be hardwired into a vehicle's electrical system, where signals are received based on driver inputs to energize the light-emitting means and illuminate the symbol.

The present invention discloses a new vehicle light covering that can be retrofitted onto existing vehicles or provided in a replacement light housing assembly. The message improves motorist communication and reduces road rage associated with congested and high traffic areas. It is submitted that the present invention substantially diverges in design elements from the prior art and consequently it is clear that there is a need in the art for an improvement to existing automotive light covering devices. In this regard the instant invention substantially fulfills these needs.

### SUMMARY OF THE INVENTION

In view of the foregoing disadvantages inherent in the known types of light covering devices and vehicle messaging means now present in the prior art, the present invention provides a new light covering that can be utilized for providing convenience for the user when displaying a message to a nearby motorist when applying an external vehicle light.

It is therefore an object of the present invention to provide a new and improved automotive light covering device that has all of the advantages of the prior art and none of the disadvantages.

It is another object of the present invention to provide an automotive light covering device that is positioned on the lens or light cover of an automobile light for partially blocking illumination to form a written message to nearby motorists.

Another object of the present invention is to provide an automotive light covering device is to provide a light covering having a message that is deployable in two alternate forms: an adhesable light covering or a vehicle-specific light cover, light lens or light housing that replaces an existing structure.

Another object of the present invention is to provide an automotive light covering device that is a passive message deployable over any type of vehicular light, requiring no power or controls to function.

Another object of the present invention is to provide an automotive light covering device that can be adapted to display any desired message or symbol preferred by the user.

Yet another object of the present invention is to provide an automotive light covering device that does not violate transportation authority regulations with respect to diminishing illumination or visualization of the underlying light.

A final object of the present invention is to provide an automotive light covering device that is readily deployable, inexpensive to manufacture and capable of being retrofitted to existing vehicles.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded perspective view of a first embodiment of the present invention.

FIG. 2 shows the application of a second embodiment of the present invention.

### DETAILED DESCRIPTION OF THE INVENTION

Reference is made herein to the attached drawings. Like reference numerals are used throughout the drawings to depict like or similar elements of the automotive light covering. For the purposes of presenting a brief and clear description of the present invention, the preferred embodiment will be discussed as used for sending a message to nearby motorists using a passive message signal when a vehicle light is energized. The figures are intended for representative purposes only and should not be considered to be limiting in any respect.

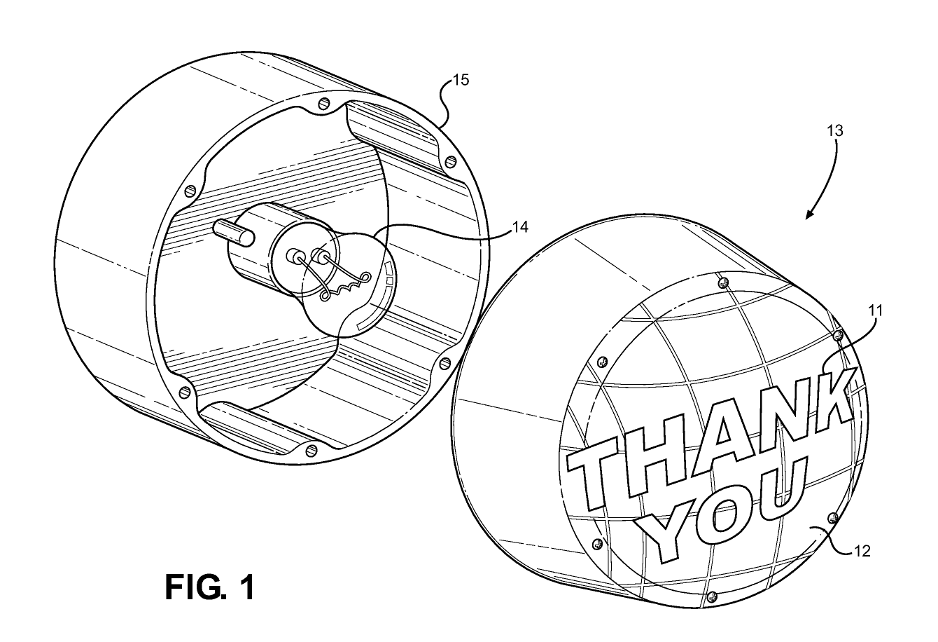

Referring now to FIG. 1, there is shown a first embodiment of the automobile light covering device of the present invention. This embodiment contemplates a replacement or original equipment lamp cover 13, lens or housing that includes a defined message 11 along its outer lens 12. The message 11 is etched, painted or otherwise presented along the lens surface 12 to partially obstruct, block or refract light at the lettering 11 locations. The underlying vehicle light 14, when energized, shines through the unblocked portions of the lens 12 and highlights the boundaries of the lettering 11 to allow other motorists to visualize the message. The lens 12 may be a replacement lens for an existing vehicle, whereby the lens 12 secures to the light housing 15 to enclose the light bulb 14 prior to deployment. Alternate structures include entire light housing assemblies, which can be removed from the vehicle and replaced using the light housing electrical connectors. The outer panel or lens of the housing includes the desired writing 11 to relay the message.

It is not desired to limit the disclosed message to a set of letters or a single configuration, but rather it is desired to disclose an improved communication means between motorists that can provided directed messages (in the case of emergency vehicles), or kind messages that build good-will and lower tensions on the roadway. It is further not contemplated t limit the deployment of the present invention to a particular light location or assembly on a vehicle. Any vehicle lighted signal, including rear taillights, turn signals, hazard lights, reverse lights or the like may utilize the present invention for displaying a sign. In a particular embodiment, the message reads “Thank You” and is placed over a vehicle rear turn signal, whereby a driver may thank nearby motorists when merging into traffic in congested or high speed areas. In another embodiment, the reverse lights may be accentuated by placing a “Reverse” lettering along their lenses for improved communication. For the replacement lens embodiment, the lens secures to an existing light housing 15 using fasteners or similar structural connectors, and the lens acts as a direct replacement for the preexisting lens on the housing. For the complete light housing replacement embodiment, the housing replaces an entire light housing and secures to the vehicle in the same structural locations and utilizes the same electrical connectors or harness provided on the original equipment light housing.

Since the present invention is pertaining to roadway vehicles and light sources thereon, is it desired to design a messaging means that does not violate state and federal government roadway safety regulations. Specifically, the present invention does not intend to block to outgoing light from a turn signal to the extent that its light is significantly reduced. Rather, the lettering is desired to be minimalist and of a shape and structure to allow ready visualization of the message while not reducing the brightness of the lights. Therefore, to comply with regulations for motor vehicles, the message letters may be shrunk in thickness, provided in stencil form to reduce surface area or etched into the lens to provide a message that does not block outgoing light. The lettering is desired to be at least partially opaque to allow light to be reduced around the lettering area, therefore allowing visualization of the message when the vehicle light is energized.

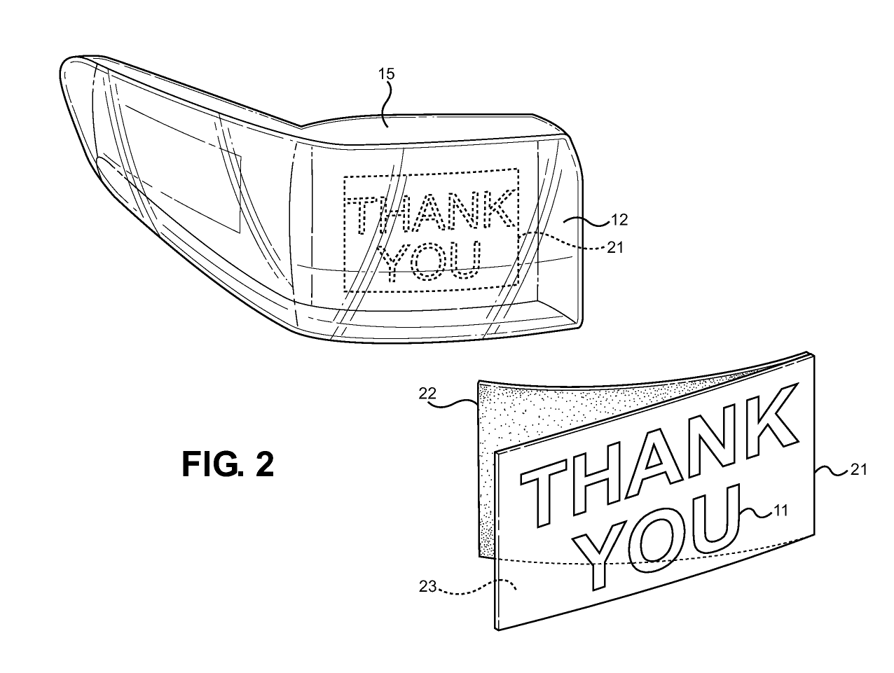

Referring now to FIG. 2, there is shown a second embodiment of the present invention. In this embodiment, the automotive light covering is an adhesable sticker structure 21 having a message 11 along its outer surface and an adhesive backside surface 23. A peel-away film 22 protects the adhesive prior to application, whereafter the message is applied to the exterior of an existing vehicular light lens 12. The sticker 21 is clear to allow light to pass therethrough, while a message 11 is provided along its outer surface to partially block outgoing light and highlight the message 11. In this embodiment, a desired message may be applied to any vehicular lighting assembly without replacement of the light lens 12, housing or any other original equipment provided on the vehicle. The message is readily applied to an existing vehicle and can be removed and replaced at a later date if desired. Similar to the lens embodiment, the sticker embodiment allows for the message to be applied to any vehicle light, providing a desired message, phrase or symbol to be positioned over the light and visible to nearby drivers when the light is energized. Both embodiments of the present invention require minimal installation and no alteration of existing vehicle electrical hardware when deployed.

Associated with the embodiments of the message device is an accompanying method of use that discloses placing a message onto a vehicle light to create good will between drivers and reduce road rage. The method includes the steps of identifying a vehicular light that is operably energized by input from the driver and placing a message over the light. The message is placed over a light such that it does not overly shroud the outgoing light while providing ready recognition of the message when the light is energized. The application of the message may include the steps of replacing an existing light housing, replacing a removable light lens on a vehicular light, or finally placing an adhesive sticker over the lens of a vehicle light to display the message during deployment. A crucial step also includes ensuring the opaque or semi-opaque message does not violate state and federal regulations for vehicle light coverings. This is accomplished before placement over a light and is location dependent, based on state regulations.

While it would be ideal if everyone put safety first while driving, it is submitted that roadway confrontations are a regular occurrence on most roadways, particularly in congested and high traffic areas. Some drivers may be in a hurry to their destination, distracted by a cell phone, or even angry about something completely unrelated to other drivers. These drivers may be susceptible to accidents and confrontations with other drivers, as it is easy to forget that other drivers are simply people attempting to navigate the roadway in the same manner, and other motorists can be serious injured if one is acting or driving recklessly. An emotionally-charged individual may overreact and cause an accident, which may do harm to that person and many others on the road. For these reasons, it is submitted that a means of reducing roadway tension between drivers and reducing road rage is necessary. The present invention provides a means to message other drivers during common roadway intersections and merge areas, and also provide a means for emergency and special vehicles to display directed messages. For instance, a merging vehicle can display a “Thank You” message on his or her vehicle's turn signal, or a series of vehicles heading to a funeral may deploy a “Funeral Service” message on their hazard lights, and finally emergency vehicles such as ambulances may deploy messages such as “Caution” when their emergency lights are activated.

Several embodiments have been disclosed, along with a method of use, whereby communication between motorists is improved for the purposes of increased roadway safety. In light of cited prior art and the foregoing description, it is submitted that the instant invention has been shown as a novel advancement of the art and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An automotive light covering device, comprising:
an exterior vehicle light lens having a transparent surface;
a message positioned on said transparent surface comprising a series of at least partially opaque lettering such that when said light is energized, said lettering is clearly visible on said lens surface.

2) The device of claim 1, wherein said lens is a direct replacement lens for an existing vehicle light lens, said replacement lens being attachable to an existing vehicular light housing having a light source therein, wherein said replacement lens secures via structural connectors to said vehicular light housing.

3) The device of claim 1, wherein said lens is attached to a direct replacement vehicular light housing for replacement of an existing light housing on a vehicle, wherein said replacement housing secures via structural connectors to said vehicle and affects electrical connection via electrical connectors to said vehicle light power source.

4) The device of claim 1, wherein said lettering spells out “Thank You.”

5) An automotive light covering device, comprising:
an adhesable sticker having an exterior surface and a backside surface;
said exterior surface having a series of at least partially opaque lettering thereon;
said backside surface comprising a layer of adhesive material;
said backside surface covered by a peel-away film;
said lettering of sufficient opacity that when said sticker is placed on a vehicle light lens and said light is energized, said lettering is clearly visible on said vehicle light lens surface.

5) The device of claim 4, wherein said lettering spells out “Thank You.”

6) A method of placing a message on a vehicle exterior light, comprising the steps of:
identifying an exterior vehicular light having an operably energized input from a driver;
positioning a message over said light having partially opaque lettering;
energizing said light via driver input to illuminate said light around said lettering to allow visualization of said message.

7) The method of claim 6, further comprising the steps of:
replacing an existing vehicle exterior light lens with a replacement lens having said message thereon via structural connectors to a vehicular light housing.

8) The method of claim 6, further comprising the steps of:
replacing an existing vehicular light housing with a replacement housing having a lens with said message thereon via structural connectors to said vehicle and electrical connectors to said vehicle light power source.

9) The method of claim 6, further comprising the steps of:
ensuring said message does not violate state and federal regulations for vehicle light coverings.

10) The method of claim 6, further comprising the steps of:
removing a peel-away film from an adhesable sticker having an adhesive backside surface and an outer surface having said lettering;
adhering said sticker to said light.
